(19) United States
(12) Patent Application Publication
(10) Pub. No.: US 2023/0040203 A1
(43) Pub. Date: Feb. 9, 2023

(54) METHOD FOR DERIVING A PARTIAL SIGNATURE WITH PARTIAL VERIFICATION

(71) Applicant: ORANGE, ISSY LES MOULINEAUX (FR)

(72) Inventor: Olivier Sanders, Chatillon Cedex (FR)

(21) Appl. No.: 17/768,114

(22) PCT Filed: Oct. 6, 2020
(86) PCT No.: PCT/FR2020/051748

§ 371 Date: Apr. 11, 2022

(30) Foreign Application Priority Data
Oct. 11, 2019 (FR) 1911300

(51) Int. Cl. H04L 9/32; H04L 9/40; H04L 9/08

(52) U.S. Cl. CPC H04L 9/3247; H04L 63/0421; H04L 9/0861; H04L 2209/42

(57) ABSTRACT

A method for deriving a partial signature for a subset of a set of messages. The method is implemented by a partial signature derivation entity and includes: receiving the set of messages and a signature of the set of messages, the signature including signature elements of the set of messages; deriving a first verification element calculated from the messages of the set other than those of the subset; deriving a second verification element to prove that the first verification element is formed correctly; and sending to a verification entity a partial signature specific to the subset, the partial signature including a constant number of elements having at least the elements of the signature of the set of messages, the first verification element and the second verification element, the partial signature being verifiable with only messages of the subset.

### CROSS-REFERENCE TO RELATED APPLICATIONS

This application is a Section 371 National Stage Application of International Application No. PCT/FR2020/051748, filed Oct. 6, 2020, which is incorporated by reference in its entirety and published as WO 2021/069827 A1 on Apr. 15, 2021, not in English.

### FIELD OF THE DISCLOSURE

The invention relates to the general field of telecommunications and more specifically relates to the security of the exchanges between communication devices using cryptographic techniques such as electronic signature techniques.

### BACKGROUND OF THE DISCLOSURE

The electronic signature is a cryptographic tool that allows authenticating any digital data, thus acting as the equivalent of the traditional handwritten signature. This technique is now ubiquitous in our daily lives, whether when browsing the Internet since the access to any URL in https involves the use of electronic signatures, or during a payment using a bank card. It also constitutes the very basis of anonymous authentication mechanisms, popularized by DAA (Direct Anonymous Attestation), and by EPID (Enhanced Privacy IDentity).

In most cases, it is not a single data that is certified, but a set of n data, with n>0, for example the name, the date of birth, the address, etc., of a person. The existing electronic signature solutions can then be grouped into two families: those that produce a signature of constant size, and the other ones whose size depends on the value of n. The former ones are of course preferable with regard to the size of the signature, but this constant cost hides a major defect: the signature is valid on the set of signed data and can therefore only be verified by transmitting all the data that have been signed. It is of course possible to use techniques called zero-knowledge proof techniques to conceal these elements, but this only solves the problem of anonymity: these proofs, which are very expensive, have a complexity in size at least linear in the number of concealed elements.

Two recent schemes are able to have a constant size, both for the signature and for the verification proof.

A first construction proposed by Camenisch et al. à Asiacrypt 2015 in the article “Composable and Modular Anonymous Credentials: Definitions and Practical Constructions” which satisfies this property, is thus known. However, by the authors' own admission, the most efficient instantiations of this construction involve proofs of more than a hundred elements, thereby excluding its use in practice. Indeed here, the verification proof is of constant size but this constant is extremely high.

More recently, Fuchsbauer et al. published in the Journal of Cryptology 2019 “Structure-Preserving Signatures on Equivalence Classes and Constant-Size Anonymous Credentials” which has a construction with the same property. Proving the validity of a signature can be done more efficiently than with the previous scheme, but the major problem here is the impossibility of proving any relationship on the certified data without revealing them. For example, it is not possible to prove the legal age of the person without revealing their date of birth, which is contrary to the spirit of anonymous attestations.

### SUMMARY

One of the aims of the invention is to address shortcomings/drawbacks of the state of the art, and/or to make improvements thereto.

To this end, the invention proposes a method for deriving a partial signature for a subset (I) of a set of messages ({m_1, . . . , m_n}), called subset of messages, said partial signature being intended to prove the validity of a signature of the set of messages for the messages of the subset of messages, said method, implemented by a partial signature derivation entity, comprising:
the receipt of the set of messages ({m_1, . . . , m_n}) and of a signature of said set of messages, said signature comprising signature elements ((q, s)) of the set of messages,
the derivation of a first verification element (A) calculated from the messages of the set other than those of the subset of messages, and
the derivation of a second verification element (B) intended to prove that the first verification element is formed correctly, and the sending to a verification entity (12) of a partial signature specific to the subset of messages, said partial signature comprising a constant number of elements comprising at least the elements of the signature of the set of messages, the first verification element (A) and the second verification element (B), said partial signature being intended to be verified with the only messages of the subset of messages.

The method describes a constant-size signature system that combines the best of two worlds. Indeed, the proof of the signature can be done very efficiently because the proof comprises a constant number of elements, the constant being of reasonable size; it indeed requires four elements of the partial signature. This system also allows verifying the validity of a signature on a subset of messages without needing to know, and therefore to transmit, the other parts of the message. This scheme can be advantageously used in all use cases requiring an authentication, whether anonymous or not.

Advantageously, the generation of the partial signature comprises an anonymization of the partial signature, said anonymization comprising:
the anonymization of the elements of the signature ((q, s)) by means of random scalars, and
the anonymization of the first and the second verification element by means of one of the random scalars.

Thanks to this anonymization, implemented by judicious addition of random elements, a signature becomes perfectly untraceable. Thus, a signature derivation entity will present, during two different authentications of the same subset of messages, a different partial signature. Indeed, with this method, the set of unrevealed messages is perfectly masked randomly. It is recognized that the non-traceability property of a signature is an important security property.

In one exemplary embodiment, the method comprises beforehand a generation of a secret key and of an associated public key in a bilinear environment, said environment referring to a first group G1, a second group G2 and a third group GT of prime order p, as well as a bilinear map e, taking as input an element of the first group G1, an element of the second group G2 and with values in the third group GT, namely g, respectively h, an element of the first group G1, respectively of the second group G2, said generation comprising:
the generation by the signing entity of (n+1) random scalars (x, y_1, . . . , y_n), said random scalars forming the secret key of the signing entity, and
the calculation by the signing entity of X=g\hat{ }{x}, Y_i=g\hat{ }{y_i} for 1≤i=j≤n, Z_{i, j}=g\hat{ }{y_i·y_j} for 1≤i≠j≤n, and H_i=h\hat{ }{y_i} for 1≤i≤n, the elements X, Y_i, Z_{i, j} and H_i forming the public key.

This exemplary embodiment describes how the secret and public keys of a signing entity are calculated.

In one exemplary embodiment, the signature of the set {1, . . . , n} of messages, denoted m_1, . . . , m_n, comprises the selection by the signing entity of a random element q from the second group G2, and the calculation of s=q\hat{ }{x+y_1·m_1+ . . . +y_n·m_n}, said signature then being (q, s).

This exemplary embodiment describes how the signature of the set of messages is calculated. It comprises two elements q and s.

In one exemplary embodiment, the derivation of the partial signature for the subset I of the set {1, . . . , n} of messages comprises:
the generation of the first verification element A=Π_{j in {1, . . . , n}\}·Y_j\hat{ }{m_j}, and
the generation of the second verification element B=Π_{i in I, j in {1, . . . , n}\}·Z_{i, j}\hat{ }{m_j}, the partial signature then being (q, s, A, B).

This exemplary embodiment precisely describes how the partial signature of the subset of messages is calculated or derived. The calculation of the partial signature comprises the calculation of two elements A and B. The messages used to calculate the first element A are the messages that are not part of the subset of messages. The second element B uses messages of which one of the subscripts, i, travels through the set I relating to the subset of messages, while the other subscript, j, relates to the messages which are not part of the subset of messages. The signature is formed of the elements of the signature of the set of messages, of the first element A and of the second element B.

In another exemplary embodiment, the signature of the set of message comprises:
the selection by the signing entity of two scalars r and t,
the calculation of q′=q\hat{ }r,
the calculation of s′=s\hat{ }r·q\hat{ }{r·t},
the generation of the first verification element A=g\hat{ }t·Π_{j in {1, . . . , n}\} Y_j\hat{ }{m_j}, and
the generation of the second verification element B=(Π_{i in I} Y_i)\hat{ }t·Π_{i in I, j in {1, . . . , n}\I} Z_{i, j}\hat{ }{m_j}, the partial signature then being (q′, s′, A, B).

This other example describes how to calculate or derive an anonymous partial signature.

Random scalars are used, thus making the partial signature completely untraceable.

The invention also relates to a method for verifying a partial signature for a subset I of a set of messages {m_1, . . . , m_n}, called subset of messages, said partial signature being intended to prove the validity of a signature of the set of messages for the messages of the subset of messages, said method, implemented by a partial signature verification entity, comprising:
the receipt of the subset of messages and of a partial signature specific to the subset of messages, said partial signature comprising a constant number of elements comprising at least the elements of the signature of the set of messages, a first verification element calculated from the messages of the set other than those of the subset of messages and a second verification element intended to prove that the first element is formed correctly,
the verification of a first equation involving the messages of the subset of messages, the elements of the signature of the set of messages as well as the first verification element and elements of the public key, and
the verification of a second equation involving the first signature verification element, the second signature verification element and elements of the public key.

The partial signature verification method is adapted to verify that a partial signature on a subset of messages is valid or not. The partial signature verification is identical whether it is a partial signature or an anonymous partial signature. Thus, whether it is a partial signature or an anonymous partial signature, the same verification method is used. The implementation of the signature scheme is thus simplified and optimized, thus offering better performance.

In one exemplary embodiment of the partial signature verification method in which a secret key and an associated public key have been generated for a signing entity in a bilinear environment, said environment referring to a first group G1, a second group G2 and a third group GT of prime order p, as well as a bilinear map e, taking as input an element of the first group G1, an element of the second group G2 and with values in the third group GT, namely g, respectively h, an element of the first group G1, respectively of the second group G2, said generation comprising:
the generation by the signing entity of (n+1) random scalars (x, y_1, . . . , y_n), and
the calculation by the signing entity of X=g\hat{ }{x}, Y_i=g\hat{ }{y_i} for 1≤i=j≤n, Z_{i, j}=g\hat{ }{y_i·y_j} for 1≤i≠j≤n, and H_i=h\hat{ }{y_i} for 1≤i≤n, the elements X, Y_i, Z_{i, j} and H_i forming the public key, the verification of the partial signature comprising:
   the verification of a first equation: e(X·A·Π_{i in I} Y_i\hat{ }{m_i}, q)=e(g, s), and
   the verification of a second equation: e(A, Π_{i in I} H_i)=e(B, h).

The different steps of the partial signature verification method are specified here.

The invention also relates to an entity for deriving a partial signature intended to derive a partial signature for a subset I of a set {1, . . . , n} of messages {m_1, . . . , m_n}, called subset of messages, said partial signature being intended to prove the validity of a signature of the set of messages for the messages of the subset of messages, said partial signature derivation entity comprising:
receiving means, arranged to receive the set of messages {m_1, . . . , m_n} and a signature (q, s) of said set of messages, said signature of the set of messages comprising signature elements of the set of messages,
means for deriving a first element, arranged to derive a first verification element A calculated from the messages of the set other than those of the subset of messages, and
second element derivation and sending means, arranged to derive a second verification element B intended to prove that the first verification element is formed correctly, and to send to a partial signature verification entity a partial signature specific to the subset of messages, said partial signature comprising a constant number of elements comprising at least the elements of the signature of the set of messages, the first verification element and the second verification element, the partial signature being intended to be verified with the only messages of the subset of messages.

The invention also relates to an entity for verifying a partial signature, intended to verify a partial signature for a subset I of a set of messages {m_1, . . . , m_n}, called subset of messages, said partial signature being intended to prove the validity of a signature of the set of messages for the messages of the subset of messages, said partial signature verification entity, comprising:
receiving means, arranged to receive the subset of messages and a partial signature (q, s, A, B) specific to the subset of messages, said partial signature comprising a constant number of elements comprising at least the elements of the signature of the set of messages, a first verification element A calculated from the messages of the set other than those of the subset of messages and a second verification element B intended to prove that the first verification element is formed correctly,
first verification means, arranged to verify a first equation involving the messages of the subset of messages, the elements of the signature of the set of messages as well as the first verification element, and elements of the public key, and
second verification means, arranged to verify a second equation involving the first verification element, the second verification element and elements of the public key.

The invention also relates to a partial signature derivation and verification system comprising:
a partial signature generation entity as described previously,
a partial signature verification entity as described previously.

The invention also relates to a use of a partial signature derivation and verification system as described previously in an anonymous credential system.

The partial signature derivation method and the partial signature verification method are particularly well adapted to the anonymous credentials. Indeed, the need to not reveal some parts of these data is evident in the field of anonymous credentials and solved by the proposed scheme. The exemplary embodiment relating to the anonymous partial signatures can be directly used as an anonymous credential system because it additionally satisfies the strongest untraceability properties, while offering better performance than the other solutions of the state of the art.

The invention also relates to a computer program on a data medium and loadable in the memory of a computer, comprising program code instructions intended to control the execution of the steps of the signature derivation method as described previously, when the program is run on said computer.

The invention also relates to a data medium in which the program described previously is recorded.

The invention also relates to a computer program on a data medium and loadable in the memory of a computer, comprising program code instructions intended to control the execution of the steps of the partial signature verification method as described previously, when the program is run on said computer.

The invention also relates to a data medium in which the program described previously is recorded.

### BRIEF DESCRIPTION OF THE DRAWINGS

Other characteristics and advantages of the present invention will be better understood from the detailed description and the appended figures, among which:

FIG. 1 presents the steps of a signature method, according to one exemplary embodiment;

FIG. 2 is a schematic representation of a partial signature derivation entity able to implement the steps of the partial signature derivation method for a subset of messages, according to one exemplary embodiment:

FIG. 3 is a schematic representation of a partial signature verification entity able to implement the steps of the partial signature verification method for a subset of messages, according to one exemplary embodiment.

### DETAILED DESCRIPTION OF ILLUSTRATIVE EMBODIMENTS

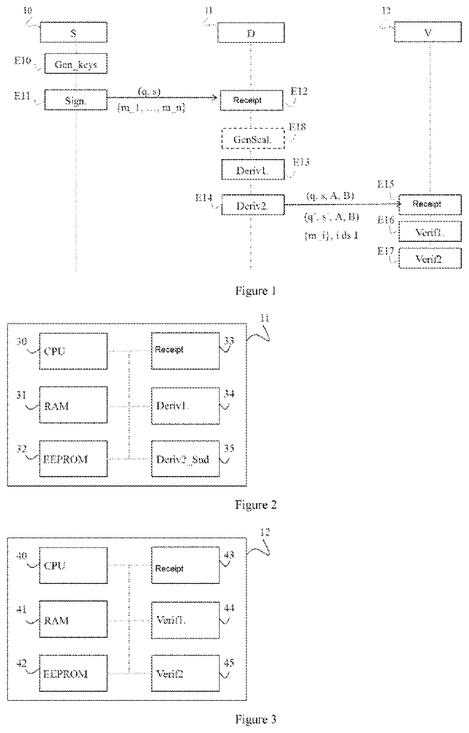

The steps of a partial verification signature method, according to a first exemplary embodiment will now be described in relation to FIG. 1.

It is noted that a usual notation in cryptography is used here in which:
“x_i” represents “x subscript i”, namely “xᵢ”;
“g\hat{ }x” represents “g to the power of x”, namely “g^{x}”,
the product is illustrated by a dot: “·”, or by the classic sign Π (capital pi) when many indexed factors are involved,
the addition is conventionally illustrated by the sign “+”, or by the sign Σ (capital sigma) when many indexed factors are involved.

The signature scheme described here operates in a bilinear environment which refers to three groups usually denoted G1, G2 and GT, of prime order p, as well as a bilinear map e called “bilinear coupling” taking as input an element of the group G1 and an element of the group G2 and with values in the group GT. This type of environment has become classic in cryptography and can be implemented very efficiently. It should be noted that the roles of G1 and G2 are perfectly interchangeable.

The signature scheme is based on a system that comprises several entities:
a signing entity 10. The signing entity 10 is a computer device which comprises code instructions to implement those of the steps of the signature derivation method implemented by the signing entity,
a partial signature derivation entity 11. The signature derivation entity 11 is a computer device which comprises code instructions to implement those of the steps of the signature derivation method implemented by the partial signature derivation entity 11,
a partial signature verification entity 12. The partial signature verification entity 12 is a computer device which comprises code instructions to implement those of the steps of the signature derivation method implemented by the partial signature verification entity 12.

It should be noted that the same entity can combine several roles. For example, a signing entity can also act as a partial signature derivation entity. Similarly, a signing entity may also be required to act as a partial signature verification entity.

As a reminder, a bilinear coupling e is a function verifying among others the following properties:

e(g\hat{ }a,h\hat{ }b)=e(g,h)\hat{ }(a·b)

e(g\hat{ }a,q)=e(g,q)\hat{ }a

In the following, n refers to the maximum number of data that can be signed at the same time. In the usual terminology, it is referred to as messages rather than data. Thus, a set {1, . . . , n} of messages to be signed, denoted {m_1, . . . , m_n} is available. For example, for an individual, such messages may be a name, an address, a date of birth, etc.

The signature scheme described here allows very efficiently verifying the validity of a signature on any subset of messages.

In a preliminary key generation step E10, the signing entity 10 generates for the signature scheme, a pair of secret/public keys Ks/Kp. It should be noted that in another exemplary embodiment, the generation of keys can be implemented by a dedicated entity, distinct from the signing entity 10, the keys, and in particular the secret key then being transmitted to the signing entity 10 in a secure manner, according to known methods not presented here.

Let g, respectively h, a random element of the group G1, respectively of the group G2, the signing entity controls the generation of (n+1) random integers smaller than p, (x, y_1, . . . , y_n), and constructs the following elements:

X=g\hat{ }{x},

Y_i=g\hat{ }{y_i} for 1<=i<=n,

Z_{i,j}=g\hat{ }{y_i·y_j} for 1<=i≠j<=n,

H_i=h\hat{ }{y_i} for 1<=I<=n

The secret key Ks of the signatory in the signature system consists of the random integers (x, y_1, . . . , y_n).

The public key Kp is formed of the elements X, Y_i, Z_{i, j}, and H_i.

Thus:

Ks=(x,y_1, . . . ,y_n), and

Kp=(X,Y_i,Z_{i,j},H_i)

Conventionally, the public key Kp is then published, here by the signing entity 10.

In a second signature step E11, the signing entity 10 signs n messages m_1, . . . , m_n by means of its secret key Ks. To this end, the signing entity 10 selects a random element q from the group G2, and calculates:

s=q\hat{ }{x+y_1·m_1+ . . . +y_n·m_n}

The signature of the set of n messages is then (q, s).

It should be noted that the signing entity 10 can also sign messages of size n′, with n′<n with this same pair of keys, that is to say, without regenerating a pair of keys. In this case, the message of size n′ to be signed is completed with ‘0’s until obtaining a message of size n, and the signing entity 10 then uses its pair of keys Ks/Kp to sign it. At the end of the signature step E11, the signing entity 10 sends the signature (q, s) of the set of n messages to the partial signature derivation entity 11 as well as the set {m_1, . . . , m_n}.

In a partial signature derivation step E12, implemented to prove the validity of the signature (q, s) on a subset of messages m_i for i belonging to a subset I of the set {1, . . . , n} of messages, the partial signature derivation entity 11 receives in a receiving sub-step E12 the signature (q, s) on the set of messages {m_1, . . . , m_n}.

The partial signature derivation entity 11 calculates or derives in a step E13 of deriving a first element, a first verification element A which aggregates all the messages m_j whose subscript j is in {1, . . . , n} but not in the subset I. The appropriate notation is {1, . . . , n}\I. The first verification element A thus relates in a way to messages that are not of interest to the signing entity 10, more specifically to the messages that are not part of those for which it wishes to prove the validity of the signature (q, s). Thus, the partial signature derivation entity 11 calculates:

A=Π_{j in {1, . . . ,n}\I}Y_j\hat{ }{m_j}

At this stage, the partial signature is then (q, s, A). This signature is specific to the messages m_i, with i in the set I, that is to say it is intended to be used to verify the validity of the signature of this subset m_i of messages based on the signature of the n messages (q, s) and with the only messages of the subset of messages.

In this exemplary embodiment, in a second element derivation and sending step E14, the partial signature derivation entity 11 calculates, or derives, a second verification element B. This second verification element B is intended to prove that the first verification element A is valid, that is to say is formed correctly. Intuitively, the second verification element B allows showing that the first verification element A, calculated from the concealed messages, is formed correctly, that is to say it cannot be used to cheat on the value of the messages m_i, for i in I, which are presented to the partial signature verification entity 12. Thus, the partial signature derivation entity 11 calculates:

B=Π_{i in I,j in {1, . . . ,n}\I}Z_{i,j}\hat{ }{m_j}

The partial signature is then (q, s, A, B). The partial signature (q, s, A, B) and the subset of messages m_i, with i in I, are then sent at the end of step E14 to the partial signature verification entity 12.

Thus, regardless of the number of messages of the subset of messages, regardless of the number of messages of the set of messages, the partial signature is of constant size and comprises few elements, in this case four elements. It should also be noted that only the messages of the subset of messages {m_i}, with i in I, are transmitted. The verification entity 12 therefore does not need to know the set of messages {m_1, . . . , m_n} or messages that would be linked by construction to messages of the subset of messages, such as for the age, the date of birth.

In a subsequent receiving step E15, the partial signature verification entity 12 receives from the signature derivation entity 11 the subset of messages {m_i}, with i in I, and the partial signature (q, s, A, B).

The partial signature verification entity 12 verifies in a first verification sub-step E16 a first equation:

e(X·A·Π_{i in I}Y_i\hat{ }{m_i},q)=e(g,s), (1)

The partial signature verification entity 12 verifies in a second step E17 of verifying a second equation:

e(A,Π_{i in I}H_i)=e(B,h), (2)

If these two equalities, or equations, are satisfied, the partial signature, relating to the subset of messages m_i, with i in I is valid. Otherwise, it is considered as invalid.

Indeed, when the first equation (1) is developed, using the definition of the first verification element A defined during step E13 of deriving a first element:

=e(X·Π_{i in I}Y_i\hat{ }{m_i}·Π_{j in {1, . . . ,n}\I}Y_j\hat{ }{m_j},q)

is obtained.

Using the definitions of X and Y:

=e(g\hat{ }x·Π_{i in I}(g\hat{ }{y_i})\hat{ }{m_i}·Π_{j in {1, . . . ,n}\I}(g\hat{ }{y_j})\hat{ }{m_j},q)

is obtained.

Using the rule (g\hat{ }a)=g\hat{ }{a·b} and the fact that the product of the Y_j\hat{ }{m_j} whose subscript j belongs to the set {1, . . . , n} deprived of the set I, and of the Y_i\hat{ }{m_i} whose subscript i is in I, are combined:

=e(g\hat{ }{x+Σ_{i in {1, . . . ,n}}y_i·m_i},q)

is obtained.

Using the property of the coupling: e(g\hat{ }a, q)=e(g, q)\hat{ }a:

=e(g,q)\hat{ }{x+Σ_{i in {1, . . . ,n}}y_i·m_i}

is obtained.

Using the coupling property which allows reintroducing an exponent on the chosen term:

=e(g,q\hat{ }{x+Σ_{i in {1, . . . ,n}}y_i·m_i})

is obtained.

Using the definition of s specified in the key generation phase P10, the term becomes:

=e(g,s)

Thus, e(X·Π_{i in I}Y_i\hat{ }{m_i}A, q)=e(g, s).

This first verification equation could suffice to verify the validity of the partial signature which relates to the messages m_i whose subscripts i are in I. However, nothing says that the first verification element A is generated correctly. This is why the partial signature verification entity 12 verifies the second equation in the second verification step E16. When the second equation (2) is developed, using the definition of the first verification element A:

=e(Π_{j in {1, . . . ,n}\I}Y_j\hat{ }{m_j},Π_{i in I}H_i)

is obtained.

Using the definition of Y and H:

=e(Π_{j in {1, . . . ,n}\I}g\hat{ }{y_j}\hat{ }{m_j},Π_{i in I}h\hat{ }{y_i})

is obtained.

Using the rule (g\hat{ }a)=g\hat{ }{a·b}:

=e(g\hat{ }{Σ_{jin {1, . . . ,n}\I}y_j·m_j},h\hat{ }Σ_{iin I}y_i)

is obtained.

Using the property of the coupling e(g\hat{ }a, h\hat{ }b)=e(g, h)\hat{ }(a·b):

=e(g,h)\hat{ }((Σ_{j in {1, . . . ,n}\I}y_j·m_j)·(Σ_{i in I}y_i))

=e(g,h)\hat{ }(E_{i in I,j in {1, . . . ,n}\I}y_j·m_j·y_i)

is obtained.

This term is equal to e(B, h). Indeed, using the definition of the second verification element B and of Z:

e(B,h)=e(Π_{i in I,j in {1, . . . ,n}\I}(g\hat{ }{y_i·y_j})\hat{ }m_j,h)

is obtained.

Using the rules (g\hat{ }a)\hat{ }b=g\hat{ }(a·b) and g\hat{ }a·g\hat{ }b=g\hat{ }{a+b}:

e(B,h)=e(g\hat{ }{Σ_{i in I,j in {1, . . . ,n}\I}(y_i·y_j·m_j)},h)

is obtained.

Using the property of the coupling e(g\hat{ }a, h)=e(g, h)\hat{ }a:

e(B,h)=e(g,h)\hat{ }{Σ_{i in I,j in {1, . . . ,n}\I}(y_i·y_j·m_j)}

is obtained.

So: e(A,Π_{i in I}H_i)=e(B,h)

is obtained.

This second equation is intended to ensure that the first verification element A, which groups all the concealed messages, that is to say the messages that are not part of the subset of messages to be signed, is formed correctly. By “formed correctly” is meant here that the first verification element A cannot be used to cheat on the value of the messages m_i, for i in I, which are presented for verification.

Indeed, by continuing to develop the second equation, the exponent of e(g, h) is:

Σ_{j in {1, . . . ,n}\I}y_j·m_j)·(Σ_{i in I}y_i)=

E_{i in I,j in {1, . . . ,n}\I}y_j·m_j·y_i

A sum of monomials of the form y_j·m_j·y_i is thus obtained. This sum of monomials is denoted polynomial P. It is observed that the subscripts i and j which occur in the same monomial are different. Indeed, the first sum involves the messages, indexed by j, which are not in I, while the second sum involves the messages, indexed by i, which are in I. Thus, it is guaranteed, with this equation, that the monomials y_j·m_j·y_i with i=j are never met, which would give a square m_j·y\hat{ }2_j.

If the partial signature derivation entity 11 has cheated, that is to say, if in the first verification element A, more specifically in the product, it has added an element Y_i\hat{ }r=g\hat{ }(r·y_i) whose subscript i would be in I, then the exponent would be of the form:

(r·y_i+Σ_{j in {1, . . . ,n}\I}y_j·m_j)·(Σ_{i in I}y_i)

Square monomials of the form r·y_i\hat{ }2 would then appear in the polynomial P, which did not appear before.

It then becomes possible to distinguish the case of a first verification element A formed correctly of an erroneous first element A. Indeed, the second verification element B is none other than g\hat{ }P. By verifying the second equation (2), the partial signature derivation entity 12 is forced to reconstruct the polynomial P. The public key comprises the elements Z_{i, j}=g\hat{ }(y_i·y_j), with i j. These elements therefore allow reconstructing all the monomials of the form y_j·m_j·y_i. In the case where the partial signature derivation entity 11 has cheated, the polynomial P contains square monomials of the form r·y\hat{ }2_i which cannot be reconstructed from the elements Z_{i, j} of the key public, which only exist with the condition i≠j. Thus, if the partial signature derivation entity 11 is honest, all the monomials necessary for the reconstruction of the polynomial P are provided in the public key. Conversely, if the partial signature derivation entity 11 has cheated, the partial signature verification entity 12 is unable to reconstruct the polynomial P.

At the end of the second partial signature verification step E17, the verification entity 12 transmits the result to any entity requesting this verification.

In a second exemplary embodiment of the partial verification signature method, the first and second signature derivation steps E13 and 14 are slightly modified so as to anonymize the signature scheme described in relation to FIG. 1. Indeed, with the scheme described previously, each time a partial signature derivation entity uses its signature to authenticate itself, it presents the same signature, which allows tracing it.

Thus, in an additional step E18 of generating scalars and calculating new elements of the signature, represented in dotted lines in FIG. 1 and implemented with the aim of proving the validity of the signature of the m messages (q, s) on a subset of messages m_i, with i in I, the partial signature derivation entity 11 generates two scalars r and t. The partial signature derivation entity 11 then calculates:

q′=q\hat{ }r,

s′=s\hat{ }r·q\hat{ }{r·t}, (q′, s′) forming the new elements of the signature. Thus, the elements of the signature (q, s) are anonymized by means of random scalars.

In this second exemplary embodiment, in step E13 of deriving the first verification element, the partial signature derivation entity 11 calculates the first verification element A as follows:

A=(g\hat{ }t)·(Π_{j in {1, . . . ,n}\I}Y_j\hat{ }{m_j})

In step E14 of deriving the second element, the partial signature derivation entity 11 calculates the second verification element B as follows:

B=(Π_{i in I}Y_i)\hat{ }t·(Π_{i in J,j in {1, . . . n}\I}Z_{i,j}\hat{ }{m_j})

The two elements A and B thus calculated depend on one of the random scalars. They are thus also anonymized.

The new partial signature is then denoted (q′, s′, A, B).

At the end of step E14 of deriving the second element, the partial signature derivation entity 11 sends to the verification entity 12 the new partial signature (q′, s′, A, B) as well as the messages m_i, with i in I.

Thus, each time the partial signature derivation entity 11 derives a partial signature on the same subset of messages for the purpose of authenticating itself, then the derived partial signature is different. The partial signature is thus anonymous and it is then impossible to trace the partial signature derivation entity 11 during its different authentications.

It should be noted that the new partial signature or anonymous partial signature (q′, s′, A, B) is verified by the signature verification entity 12 in the same way as in the first exemplary embodiment, that is to say it is processed in the same way as a non-anonymous partial signature. More specifically, this verification takes as input the subset of messages {m_i}, with i in I, the anonymous partial signature (q′, s′, A, B) and verifies the same two equalities (1) and (2) described previously.

Thus, the implementation of the partial signature derivation is facilitated since depending on whether the partial signature is anonymous or not, the implementation of the verification of the partial signature is identical.

This embodiment is particularly suitable for use in the anonymous attestations or credentials. An anonymous attestation allows proving a property or a right related to its holder, without revealing his identity. It protects the private life of the holder of the anonymous credential by providing the property of anonymity and here of non-traceability. It takes the form here of a cryptographic data: the partial signature, which can be shown by its holder, here the partial signature derivation entity 11, to an organization, here the partial signature verification entity 12, to prove a property related to his identity.

A partial signature derivation entity, according to one exemplary embodiment, will now be described in relation to FIG. 2.

The partial signature derivation entity 11 is a piece of computing equipment, such as a computer.

The partial signature derivation entity 11 comprises:
a processing unit or processor 30, or CPU (Central Processing Unit), intended to load instructions into memory, to execute them, to perform operations;
a set of memories, including a volatile memory 31, or RAM (Random Access Memory) used to execute code instructions, store variables, etc., and a storage memory 32 of the EEPROM (Electrically Erasable Programmable Read Only Memory) type. Particularly, the storage memory 32 is arranged to store a partial signature derivation software module which comprises code instructions for implementing the steps of the partial signature derivation method as described previously and which are implemented by the partial signature derivation entity 11. The storage memory 32 is also arranged to store in a secure area the public key Kp of the signature scheme.

The partial signature derivation entity 11 also comprises:
a receiving module 33, arranged to receive the set {m_1, . . . , m_n} of messages and a signature of said set of messages. The signature of the set of messages comprises signature elements, denoted (q, s) of the set of messages. The receiving module 33 is arranged to implement step E12 of the partial signature derivation method,
a module 34 for deriving a first verification element, arranged to derive a first verification element A calculated from the messages of the set other than those of the subset of messages,
a module 35 for deriving a second verification and sending element, arranged to derive a second verification element B intended to prove that the first verification element A is formed correctly and to send to a partial signature verification entity a partial signature specific to the subset of messages, said partial signature comprising a constant number of elements comprising at least the elements of the signature of the set of messages, the first verification element A and the second verification element B. The partial signature is intended to be verified with the only messages of the subset of messages. The derivation and sending module 34 is arranged to implement the steps E13 and E14 of the partial signature derivation method as described previously.

The receiving module 33, the derivation module 34 of a first verification element and the derivation module 35 of a second verification and sending element are preferably software modules comprising software instructions for implementing those of the steps of the partial signature derivation method implemented by the partial signature derivation entity.

In a second exemplary embodiment, the partial signature derivation entity 11 comprises a module (not represented in FIG. 2) for deriving an anonymous partial signature. This module is arranged to generate random scalars and to calculate new elements of the signature. Thus, this module generates two scalars r and t, then calculates:

q′=q\hat{ }r,

s′=s\hat{ }r·q\hat{ }{r·t}, (q′, s′) forming the new elements of the signature.

In this exemplary embodiment, the module 34 for deriving the first verification element is arranged to calculate the first element A as follows:

A=g\hat{ }t·Π_{j in {1, . . . ,n}\I}Y_j\hat{ }{m_j}.

The module 35 for deriving the second verification and sending element is arranged to calculate the second verification element B as follows:

B=(Π_{i in I}Y_i)\hat{ }t·Π_{i in I,j in {1, . . . n}\I}Z_{i,j}\hat{ }{m_j}.

The first and second verification elements A and B are thus anonymized by means of one of the random scalars.

The new partial signature is denoted (q′, s′, A, B). In this exemplary embodiment, the module 35 for deriving the second verification and sending element is also arranged to send the new partial signature (q′, s′, A, B) to the partial signature verification entity 12.

The invention therefore also relates to:
a computer program including instructions for implementing the steps of the partial signature derivation method as described previously and implemented by the partial signature derivation entity when this program is run by a processor of the partial signature derivation device,
a readable recording medium on which the computer program described previously is recorded.

A partial signature verification entity, according to one exemplary embodiment, will now be described in relation to FIG. 4.

The partial signature verification entity 12 is computer equipment, such as a computer.

The partial signature verification entity 12 comprises:
a processing unit or processor 40, or CPU, intended to load instructions into memory, to execute them, to perform operations;
a set of memories, including a volatile memory 41, or RAM used to execute code instructions, store variables, etc., and a storage memory 42 of the EEPROM type. Particularly, the storage memory 42 is arranged to store a partial signature verification software module which comprises code instructions for implementing the steps of the partial signature derivation method as described previously and which are implemented by the partial signature verification entity 12. The storage memory 42 is also arranged to store the public key Kp of the signature scheme.

The partial signature verification entity 11 also comprises:
a receiving module 43, arranged to receive the subset of messages and the partial signature (q, s, A, B) of the partial signature derivation entity 11. The receiving module 43 is arranged to implement the receiving step E15 of the partial signature derivation method as described previously,
a first verification module 44, arranged to verify a first equation involving the messages of the subset of messages, the elements of the signature of the set of messages as well as the first verification element and elements of the public key. The first verification module 44 is arranged to implement step E16 of verifying a first equation of the partial signature derivation method as described previously, and
a second verification module 45, arranged to verify a second equation involving the first partial signature verification element, the second partial signature verification element, and elements of the public key. The second verification module 45 is arranged to implement step E17 of verifying a second equation of the partial signature derivation method as described previously.

The receiving module 43, the first verification module 44 and the second verification module 45 are preferably software modules comprising software instructions for implementing the steps of the partial signature derivation method described previously and implemented by the partial signature verification entity 12.

The invention therefore also relates to:
a computer program including instructions for implementing the steps of the partial signature derivation method as described previously and which are implemented by the partial signature verification entity 12 when this program is run by a processor of the partial signature verification device,
a readable recording medium on which the computer program described previously is recorded.

The invention also relates to a partial signature derivation and verification system comprising:
a partial signature derivation entity 11 as described previously, and
a partial signature verification entity 12 as described previously.

Although the present disclosure has been described with reference to one or more examples, workers skilled in the art will recognize that changes may be made in form and detail without departing from the scope of the disclosure and/or the appended claims.

1. A partial signature derivation method for deriving a partial signature for a subset (I) of a set of messages ({m_1, . . . , m_n}), called subset of messages, said partial signature being intended to prove validity of a signature of the set of messages for the messages of the subset of messages, said method, implemented by a partial signature derivation entity, comprising:
receiving the set of messages ({m_1, . . . , m_n}) and a signature of said set of messages, said signature comprising signature elements ((q, s)) of the set of messages,
deriving a first verification element (A) calculated from the messages of the set other than those of the subset of messages, and
deriving a second verification element (B) to prove that the first verification element is formed correctly, and sending to a verification entity a partial signature specific to the subset of messages, said partial signature comprising a constant number of elements comprising at least the elements of the signature of the set of messages, the first verification element (A) and the second verification element (B), said partial signature verifiable with the only messages of the subset of messages.

2. The partial signature derivation method according to claim 1 comprising generating the partial signature, which comprises an anonymization of the partial signature, said anonymization comprising:
anonymizing the elements of the signature ((q, s)) by using random scalars, and
anonymizing first and the second verification element by using one of the random scalars.

3. The partial signature derivation method according claim 1 comprising beforehand generating a secret key and of an associated public key in a bilinear environment, said environment referring to a first group G1, a second group G2 and a third group GT of prime order p, as well as a bilinear map e, taking as input an element of the first group G1, an element of the second group G2 and with values in the third group GT, namely g, respectively h, an element of the first group G1, respectively of the second group G2, said generating comprising:
generating by a signing entity of (n+1) random scalars (x, y_1, . . . , y_n), said random scalars forming the secret key of the signing entity, and
calculating by the signing entity X=g\hat{ }{x}, Y_i=g\hat{ }{y_i} for 1≤i=j≤n, Z_{i, j}=g\hat{ }{y_i·y_j} for 1≤i≠j≤n, and H_i=h\hat{ }{y_i} for 1≤i≤n, the elements X, Y_i, Z_{i, j} and H_i forming the public key.

4. The partial signature derivation method according claim 1, wherein the signature of the set {1, . . . , n} of messages, denoted m_1, . . . , m_n, comprises selecting by a signing entity a random element q from the second group G2, and calculating s=q\hat{ }{x+y_1·m_1+ . . . +y_n·m_n}, said signature then being (q, s).

5. The partial signature derivation method according to claim 1, wherein the derivation of the partial signature for the subset (I) of the set {1, . . . , n} of messages comprises:
generating the first verification element A=Π_{j in {1, . . . , n}\I}. Y_j\hat{ }{m_j}, and
generating the second verification element B=Π_{i in I, j in {1, . . . , n}\I}·Z_{i, j}\hat{ }{m_j}, the partial signature then being (q, s, A, B).

6. The partial signature derivation method according to claim 1, wherein the signature of the set of messages comprises:
selecting by a signing entity of two scalars r and t,
calculating q′=q\hat{ }r,
calculating s′=s\hat{ }r·q\hat{ }{r·t},
generating the first verification element A=g\hat{ }t·Π_{j in {1, . . . , n}\I} Y_j\hat{ }{m_j}, and
generating the second verification element B=(Π_{i in I}Y_i)\hat{ }t·Π_{i in I, j in {1, . . . , n}\I}_Z_{i, j}\hat{ }{m_j}, the partial signature then being (q′, s′, A, B).

7. A method for verifying a partial signature for a subset (I) of a set of messages ({m_1, . . . , m_n}), called subset of messages, said partial signature being intended to prove validity of a signature of the set of messages for the messages of the subset of messages, said method, implemented by a partial signature verification entity, comprising:
receiving the subset of messages and a partial signature ((q, s, A, B), (q′, s′, A, B)) specific to the subset of messages, said partial signature comprising a constant number of elements comprising at least the elements of the signature of the set of messages ((q, s), (q′, s′)), a first verification element (A) calculated from the messages of the set other than those of the subset of messages and a second verification element (B) intended to prove that the first element is formed correctly,
verifying a first equation involving the messages of the subset of messages, the elements of the signature of the set of messages as well as the first verification element and elements of a public key, and
verifying a second equation involving the first signature verification element, the second signature verification element and elements of the public key.

8. The partial signature verification method according to claim 7, comprising generating a secret key and the associated public key for a signing entity in a bilinear environment, said environment referring to a first group G1, a second group G2 and a third group GT of prime order p, as well as a bilinear map e, taking as input an element of the first group G1, an element of the second group G2 and with values in the third group GT, namely g, respectively h, an element of the first group G1, respectively of the second group G2, said generating comprising:
generating by the signing entity of (n+1) random scalars (x, y_1, . . . , y_n), and
calculating by the signing entity X=g\hat{ }{x}, Y_i=g\hat{ }{y_i} for 1≤i=j≤n, Z_{i, j}=g\hat{ }{y_i·y_j} for 1≤i≠j≤n, and H_i=h\hat{ }{y_i} for 1≤i≤n, the elements X, Y_i, Z_{i, j} and H_i forming the public key, the verification of the partial signature comprising:
verifying a first equation: e(X·A·Π_{i in I} Y_i\hat{ }{m_i},q)=e(g, s), and
verifying a second equation: e(A, Π_{i in I} H_i)=e(B, h).

9. An entity for deriving a partial signature for a subset (I) of a set ({1, . . . , n}) of messages ({m_1, . . . , m_n}), called subset of messages, said partial signature being intended to prove validity of a signature of the set of messages for the messages of the subset of messages, said partial signature derivation entity comprising:
at least one processor; and
at least one non-transitory computer-readable medium comprising instructions stored thereon which when executed by the at least one processor configure the entity to:
receive the set of messages ({m_1, . . . , m_n}) and a signature ((q, s)) of said set of messages, said signature of the set of messages comprising signature elements of the set of messages, and
derive a first verification element (A) calculated from the messages of the set other than those of the subset of messages, and
derive a second verification element (B) to prove that the first verification element is formed correctly, and send to a partial signature verification entity a partial signature specific to the subset of messages, said partial signature comprising a constant number of elements comprising at least the elements of the signature of the set of messages, the first verification element and the second element verification, the partial signature being verifiable with only the messages of the subset of messages.

10. An entity for verifying a partial signature for a subset (I) of a set of messages ({m_1, . . . , m_n}), called subset of messages, said partial signature being intended to prove the validity of a signature of the set of messages for the messages of the subset of messages, said partial signature verification entity; comprising:
at least one processor; and
at least one non-transitory computer-readable medium comprising instructions stored thereon which when executed by the at least one processor configure the entity to:
receive the subset of messages and a partial signature ((q, s, A, B)) specific to the subset of messages, said partial signature comprising a constant number of elements comprising at least the elements of the signature of the set of messages, a first verification element (A) calculated from the messages of the set other than those of the subset of messages and a second verification element (B) to prove that the first verification element is formed correctly,
verify a first equation involving the messages of the subset of messages, the elements of the signature of the set of messages as well as the first verification element, and elements of a public key, and
verify a second equation involving the first verification element, the second verification element and elements of the public key.

11. (canceled)

12. (canceled)

13. A non-transitory, computer-readable medium having stored thereon instructions which, when executed by a processor cause the processor to implement a method for deriving a partial signature for a subset (I) of a set of messages ({m_1, . . . , m_n}), called subset of messages, said partial signature being intended to prove validity of a signature of the set of messages for the messages of the subset of messages, the method comprising:
receiving the set of messages ({m_1, . . . , m_n}) and a signature of said set of messages, said signature comprising signature elements ((q, s)) of the set of messages,
deriving a first verification element (A) calculated from the messages of the set other than those of the subset of messages, and
deriving a second verification element (B) to prove that the first verification element is formed correctly, and sending to a verification entity a partial signature specific to the subset of messages, said partial signature comprising a constant number of elements comprising at least the elements of the signature of the set of messages, the first verification element (A) and the second verification element (B), said partial signature verifiable with the only messages of the subset of messages.

14. (canceled)

15. A non-transitory computer-readable medium having stored thereon instructions which, when executed by a processor cause the processor to implement a method for verifying a partial signature for a subset (I) of a set of messages ({m_1, . . . , m_n}), called subset of messages, said partial signature being intended to prove validity of a signature of the set of messages for the messages of the subset of messages, the method comprising:
receiving the subset of messages and a partial signature ((q, s, A, B), (q′, s′, A, B)) specific to the subset of messages, said partial signature comprising a constant number of elements comprising at least the elements of the signature of the set of messages ((q, s), (q′, s′)), a first verification element (A) calculated from the messages of the set other than those of the subset of messages and a second verification element (B) intended to prove that the first element is formed correctly,
verifying a first equation involving the messages of the subset of messages, the elements of the signature of the set of messages as well as the first verification element and elements of a public key, and
verifying a second equation involving the first signature verification element, the second signature verification element and elements of the public key.

16. (canceled)

17. The method for verifying a partial signature according to claim 7, comprising using the method in an anonymous credential system.
